(19) United States
(12) Patent Application Publication
(10) Pub. No.: US 2012/0136846 A1
(43) Pub. Date: May 31, 2012

(54) METHODS OF HASHING FOR NETWORKS AND SYSTEMS THEREOF

(76) Inventors: Haoyu SONG, Edison, NJ (US); Murali KODIALAM, Marlboro, NJ (US); Fang HAO, Morganville, NJ (US); T.V. LAKSHMAN, Morganville, NJ (US)

(21) Appl. No.: 12/956,391

(22) Filed: Nov. 30, 2010

(51) Int. Cl. G06F 17/30; G06F 7/00

(52) U.S. Cl. 707/698; 707/754; 707/741; 707/E17.044; 707/E17.059; 707/E17.083

(57) ABSTRACT

Example embodiments are directed to methods of hashing for networks and systems thereof. At least one example embodiment provides a method of processing elements in a system. The method includes receiving a first element, generating a first plurality of hash values based on the first element and a first plurality of hash functions, determining a first plurality of buckets in a table based on the first plurality of hash values, each of the first plurality of buckets associated with a different one of the hash values, selecting one of the first plurality of buckets, storing a first associated value in the selected bucket, the first associated value being associated with the first element, and encoding an identifier (ID) of the hash function generating the hash value associated with the selected bucket into a filter based on the hash value.

### BACKGROUND

Hash tables are ubiquitous data structures used in packet processing applications. For high-speed packet processing, the hash-table must be capable of handling fast lookups and inserts. Also, to achieve consistent packet-forwarding throughput, it is important for the hash-table to have predictable performance particularly for look-ups. Variation in lookup time can cause variable latency or out-of-order look-ups. Not only does this complicate a system design, but the system becomes prone to denial-of-service attacks. To counter the effect, hash-table collisions are avoided to the extent possible.

Hash collisions can be avoided by using perfect hashing. However, conventional perfect hashing has high implementation costs and is often not fast-enough for packet-processing applications. An example of perfect hashing is the multi-hashing scheme which approximates perfect-hashing at the cost of more, but constant, hash-table accesses per look-up. However, a higher number of accesses translates to a higher memory-bandwidth for a given throughput and higher power consumption. This in turn results in higher system cost and power consumption.

Recently, several conventional schemes that make use of an on-chip auxiliary data-structure, such as Bloom Filters, have been reported. The basic idea is to use small on-chip memory as an aid for achieving predictable lookups in the off-chip hash-table. However, these conventional schemes are either inefficient in their on-chip memory usage or are difficult to implement in practice. Moreover, these conventional schemes have only been devised to approach perfect hashing.

### SUMMARY

Example embodiments are directed to methods of hashing for networks and systems thereof. Example embodiments may use on-chip memory for achieving perfect hashing like behavior. Elements of packets are stored in a hash-table using a hash function from a pool of hash functions that can avoid hash collision. An identifier (ID) of the hash function is encoded by the on-chip memory. The coded hashing according to example embodiments is amenable to high-speed implementations and is flexible in permitting memory-performance tradeoffs.

At least one example embodiment provides a method of processing a packet. The method includes receiving a first element, generating a first plurality of hash values based on the first element and a first plurality of hash functions, determining a first plurality of buckets in a table based on the first plurality of hash values, each of the first plurality of buckets associated with a different one of the hash values, selecting one of the first plurality of buckets, storing a first associated value in the selected bucket, the first associated value being associated with the first element, and encoding an identifier (ID) of the hash function generating the hash value associated with the selected bucket into a filter based on the hash value.

At least another example embodiment discloses a method of retrieving elements in a table. The method includes receiving, by the system, a look-up request for a first element, generating, by the system, a plurality of hash values based on the look-up request, the plurality of hash values being index values for a table, first determining, by the system, a first hash function identifier (ID) based on the look-up request, and second determining, by the system, whether the first element is stored in the table based on the hash function identifier.

At least another example embodiment discloses a hashing system including a hash generator configured to receive an element and generate a plurality of hash values based on the element and a plurality of hash functions, a selector configured to select one of a plurality of buckets in a hash table based on the plurality of hash values, each of the plurality of buckets associated with a different one of the hash values, the hash table having the plurality of buckets, the hash table configured to store a value associated with the element in the selected bucket, and a filter configured to encode an identifier (ID) of the hash function generating the hash value associated with the selected bucket.

### BRIEF DESCRIPTION OF THE DRAWINGS

Example embodiments will be more clearly understood from the following detailed description taken in conjunction with the accompanying drawings. FIGS. 1-4 represent non-limiting, example embodiments as described herein.

FIG. 1 illustrates a system according to an example embodiment;

FIG. 2A illustrates an example embodiment of a single load balanced Bloom filter;

FIG. 2B illustrates an example embodiment of a plurality of partial Bloom filters;

FIG. 3 illustrates a method of inserting an element according to an example embodiment; and

FIG. 4 illustrates a method of retrieving an element according to an example embodiment.

### DETAILED DESCRIPTION

Various example embodiments will now be described more fully with reference to the accompanying drawings in which some example embodiments are illustrated. In the drawings, the thicknesses of layers and regions may be exaggerated for clarity.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It is convenient at times to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes (e.g., a scheduler located at a cell site, base station or Node B). Such existing hardware may include one or more Central Processing Units (CPUs), digital signal processors (DSPs), application-specific-integrated-circuits, field programmable gate arrays (FPGAs) computers or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of example embodiments are typically encoded on some form of tangible (or recording) storage medium or implemented over some type of transmission medium. The tangible storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. Example embodiments are not limited by these aspects of any given implementation.

Example embodiments disclose coded hashing, a general hardware-based approach to implement hash-tables to avoid collisions and achieve perfect hashing with high probability.

In at least some example embodiments, which are described below, a hash function is selected from a plurality of hash functions such that the selected hash function hashes a received element into an empty table bucket. Throughout the description of example embodiments, a bucket may be referred to as a slot.

The hashed value of the element is inserted into the empty table bucket and an identifier (ID) of the selected hash function for the element is stored. To look-up an element, an on-chip chip data structure (e.g., an error correction combinatorial bloom filter) is first queried using the element as a key. The on-chip data structure returns the ID of the selected hash function. The element is then hashed using the selected hash function to access the hash-table. The plurality of hash functions reduces the collision rate irrespective of a hash-table load.

On-chip may refer to a data structure and/or storage using logic resources and/or embedded memory on a processor. Off-chip may refer to a data structure and/or storage (e.g., hash table) that utilizes external memory devices such as random access memory chips.

Coded hashing according to example embodiments maximizes bandwidth utilization of an interface between the on-chip data side and the off-chip hash-table by inspecting one single element bucket in the off-chip hash-table. Example embodiments may be implemented in various packet handling functions such as longest prefix matches, packet classification, flow monitoring and packet scheduling.

### Discussion of Coded Hashing

During an element insertion process, the inventors have discovered that an empty bucket in a hash-table may be found for an element provided there are enough hash functions in a hash function pool (plurality of hash functions).

When n≦m, where n is a number of elements to be stored and m is a number of buckets of an off-chip hash-table, a collision-free hash-table may be provided if there are enough hash functions. A number of hash functions is based on a hash-table load factor α, where

α=n/m (1)

There may be r hash functions for inserting n elements into an m bucket hash-table without a collision. Each element is hashed r times using the r hash functions. As a result, r hash-table buckets are indicated from the hashing. The r hash-table buckets are examined to see if any of the r hash-table buckets are empty. The element is inserted into any empty bucket among the r hash-table buckets.

To reduce the possibility that no empty bucket is found, the values of r and m are chosen. Generally, r and m are chosen by the system to be as large as the system resources allow. In most cases, m is limited for better memory efficiency. A larger r will always give better performance, but is relative small compared to a maximum value to obtain a reasonable α.

When an i-th element is being inserted, i−1 elements have already been inserted. Thus, the probability that the i-th element cannot find an empty bucket is

$${( \frac{i - 1}{m} )}^{r} .$$

Consequently, the i-th element can be successfully inserted in an empty bucket with the probability

$$1 - {( \frac{i - 1}{m} )}^{r} .$$

Therefore, the probability that all the n elements can be inserted into the hash-table is:

pₛ=Πᵢ₌₁ⁿ⁻¹(1−(i/m)^{r}) (2)

A large pₛ is achieved by increasing r or m. As discussed below, example embodiments discloses multiple hash functions for each element and storing a hash function ID to retrieve the hashed element.

### Discussion of Coded Hashing System

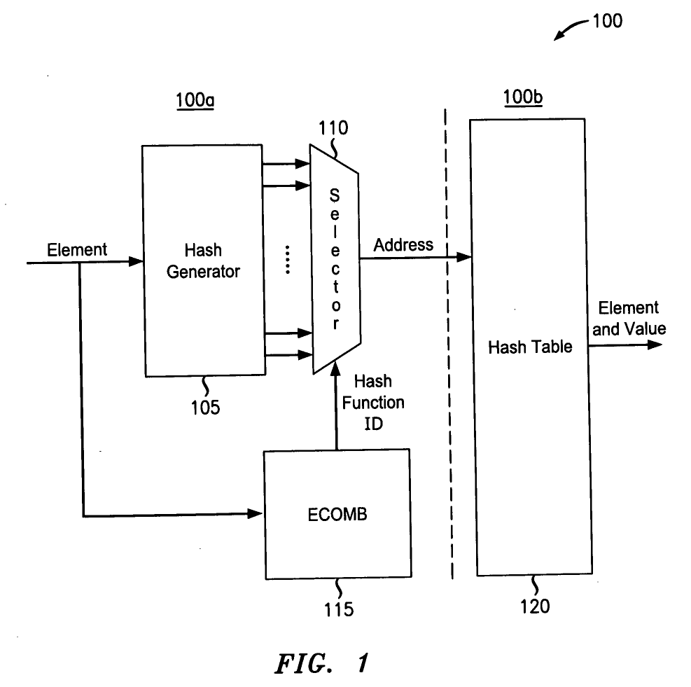

FIG. 1 illustrates a coded hashing system according to an example embodiment. As shown in FIG. 1, a coded hashing system 100 includes an on-chip side 100a and an off-chip side 100b.

The on-chip side 100a includes a hash generator 105, a selector 110 and an error correction combinatorial bloom filter (ECOMB) 115. The off-chip side 100b includes a hash table 120.

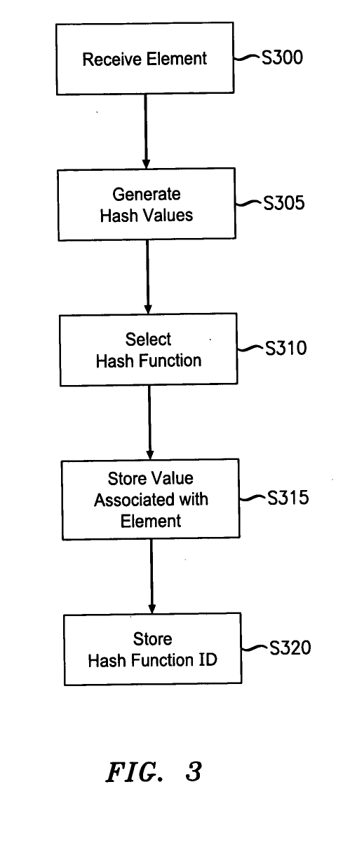

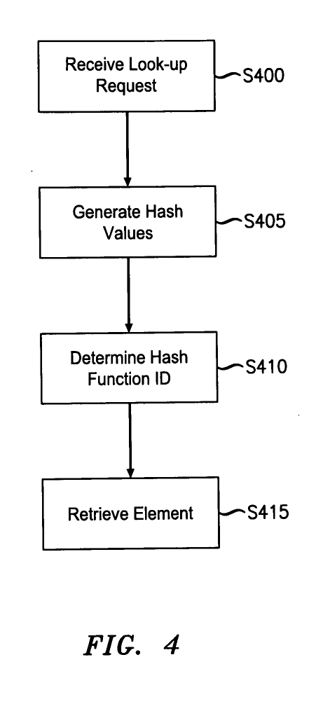

The hash generator 105 is configured to receive an element, hash the element with a plurality of hash functions, and generate a plurality hash values. The plurality of hash values are input to the selector 110 and used to access the hash table 120. The hash generator 105 is described in more detail with reference to FIGS. 3-4. Moreover, functions and structure of the hash generator 105 are described in Song et al., “IPv6 Lookups using Distributed and Load Balanced Bloom Filters for 100 Gbps Core Router Line Cards,” IEEE INFOCOM 2009, Rio De Janeiro, Brazil, Apr. 19-Apr. 25, 2009, Section V-B and U.S. Patent Appln. Publication No. 2010/0040066, the entire contents of each of which are herein incorporated by reference.

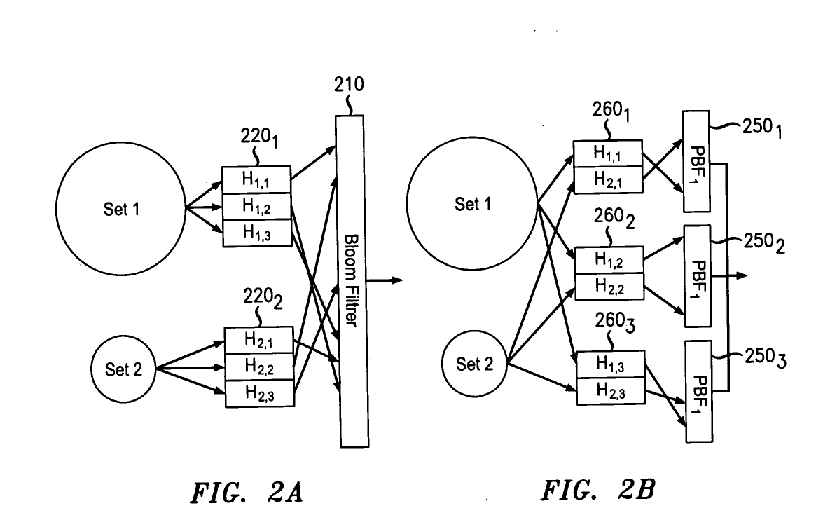

The ECOMB 115 is configured to encode and retrieve an ID of a hash function used to hash an element into the hash-table. The error correction code in the ECOMB 115 may be any known error correction block code used in communications. The ECOMB 115 may include a single load balanced Bloom filter or a plurality of partial Bloom filters. The ECOMB 115 is described in more detail with reference to FIGS. 2A-4. Moreover, functions and structure of the ECOMB 115 are described in Hao et al., “Fast Dynamic Multiset Membership Testing Using Combinatorial Bloom Filters,” IEEE INFOCOM 2009, Rio De Janeiro, Brazil, Apr. 19-Apr. 25, 2009 and U.S. Patent Appln. Publication No. 2010/0269024, the entire contents of each of which are herein incorporated by reference.

FIGS. 2A and 2B illustrate example embodiments of a single load balanced Bloom filter included in the ECOMB 115 and a plurality of partial Bloom filters included in the ECOMB 115, respectively. The Bloom filters shown in FIGS. 2A and 2B are used to encode the hash function ID. In Bloom filters, each element is hashed by every hash function and multiple bits in Bloom filters are set in turn. When searching a Bloom filter, if all the bits corresponding to a set of hash functions (e.g. 220-1 in FIG. 2A) are found to be ‘1’, the element most likely belongs to this set (e.g. Set 1 in FIG. 2A). Each set of elements is dedicated to a hash function ID for the off-chip hash table where the elements are actually stored.

When elements belong to different sets and each set is stored in a different Bloom filter, variable and dynamic set sizes make memory allocation for these Bloom filters inefficient and the coded hashing system design complex. The inventors have discovered that this problem can be solved by using one Bloom filter to implement k logical Bloom filters. Given a target false positive rate, the ratio of the elements to the Bloom filter size is fixed. The architecture showed in FIGS. 2A and 2B is equivalent to implementing an individual Bloom filter for each set.

For example, FIG. 2A illustrates a single Bloom filter 210 configured to implement a plurality of logical Bloom filters. In other words, the Bloom filter 210 is configured to implement the function of k Bloom filters. Hash groups 220ᵢ are respectively associated with sets of elements. The hash functions Hᵢⱼ hash elements in their respective set into hash values, which are address values of the single Bloom filter 210. In example embodiments, each set corresponds to the ID of a hash function, as opposed to different prefix lengths. As shown, each hash group 220ᵢ includes r hash functions. In FIG. 2A, r equals three as an example, but it should be understood that r may be any number greater than or equal to one. Moreover, FIG. 2A illustrates two sets as an example, however, it should be understood than any number of sets greater than or equal to one may be used.

The Bloom filter 210 is configured to output a hash function ID based on the hash values input to the Bloom filter 210. The hash function ID identifies the hash function used to store the hash value of the element in the hash-table. More specifically, the Bloom filter 210 outputs an answer to which set an element belongs. The set is identified by the hash function ID.

Elements that use hash function Hᵢ belong to set 1. The elements that use hash function Hᵢ belong to set i. If we use k hash functions in total, we will have k sets (so k Bloom filters). The k Bloom filters are implemented using distributed and load-balancing architecture as shown in FIGS. 2A and 2B, respectively. The k Bloom filters encode the hash function IDs. It should be understood that each of the k Bloom filters requires a number of hash functions to program. The hash functions for the k Bloom filters are different from the hash functions for the hash table 100b. A number of hash functions for each of the k Bloom filters is calculated based on the number of elements and the size the of the k Bloom filters. FIGS. 2A and 2B illustrate how the k Bloom filters are implemented. For simplicity only 2 sets and 6 hash functions (3 for each of the k Bloom filters) are shown. However, it should be understood that the numbers of sets and number of hash functions should not be limited thereto. The hash functions used in the ECOMB 115 may be further referred to as filter hash functions.

To differentiate set membership, r unique hash functions are dedicated to each hash group 220ₛ, where s is greater than or equal to one. r hash functions may be generated by XORing the output of any subset of the seed hash functions. Using this method, 255 hash functions may be virtually supported with 8 seed functions. The elements in a set are programmed into the Bloom filter 210 using the group of hash functions corresponding to the hash group 220ₛ. For example, an element in set 1 may be programmed by any one of hash functions H_{1,1}, H_{1,2} and H_{1,3}.

For element lookups, the hash functions Hₛⱼ query the Bloom filter 210 and the element is claimed to be found if any hash group 220ₛ returns all positive results. Searching uses the same set of hash functions as programming. Therefore, if all searched bits are ‘1’, the system determines that the searched element is programmed in the Bloom filter.

A size of the Bloom filter 210 is based on the total number of elements from all the sets and is independent of the individual set sizes. Thus, the Bloom filter 210 equalizes the false positive rate for every element, even if the set size is changed or the distribution is skewed.

FIG. 2B illustrates another example embodiment. To support fast parallel lookups, the hash functions Hᵢⱼ may be reorganized and each logical Bloom filter may be partitioned into k distributed partial Bloom filters 250ₜ, where t is greater than or equal to two. Each partial Bloom filter 250ₜ implements a different portion of the Bloom filter 210. This distributed implementation enables the Bloom filter 210 to be hashed in parallel.

As shown in FIG. 2B, each element in a set is hashed s times into s hash groups 260ₘ (260₁-260₃).

The Bloom filter 210 and partial Bloom filters 250ₜ are further described in H. Song et al., “IPv6 Lookups using Distributed and Load Balanced Bloom Filters for 100 Gbps Core Router Line Cards,” IEEE INFOCOM, 2009, already incorporated by reference, and H. Song et al., “Distributed and Load Balanced Bloom Filters for Fast IP Lookups,” the entire contents of which are herein incorporated by reference.

By combining the load-balance Bloom filter 210 or partial Bloom filters 250ₗ and the hash generator 105, set membership queries may be determined. Each element is hashed into the hash-table 120 using the hash functions from one of the hash groups 220ᵢ or 260ₘ.

FIGS. 1 and 2A-2B are described in greater detail with reference to the methods shown in FIGS. 3-4.

### Discussion of Coded Hashing Methods

While the methods of FIGS. 3-4 are described with reference to the coded hashing system of FIG. 1, it should be understood that the methods should not be limited to being implemented in the coded hashing system of FIG. 1.

As shown in FIG. 3, at S300, the hash generator 105 receives an element. For example, the element may be an Internet Protocol (IP) prefix. Thus, each set of elements may be associated with a length of the IP prefix. The hash generator 105 then generates a series of indexed hash values for the element at S305. The hash values are used as hash-table addresses to test whether the corresponding hash-table buckets are empty.

The hash-table bucket occupancy may be tested using the hash values generated in the order from a first to a last hash function.

At S310, one of the hash functions is selected by the selector 110. The hash value of the selected hash function is an address for one of the empty buckets. A value associated with the element is stored in the selected empty bucket at S315. The value can be anything relevant, such as a next hop or output port associated with the element (e.g., IP prefix).

The element may be inserted into the first empty bucket that is encountered during the hash-table bucket occupancy test. Thus, the first hash function handles a large number of elements. The first hash function may be designated as the default function. Consequently, all elements using the default hash function do not need to be stored into the ECOMB 115.

An on-chip bitmap may be used to avoid off-chip memory accesses. Each bit in the bitmap corresponds to a hash-table bucket and indicates the occupancy of the bucket. By examining the bitmap, the insertion process can quickly identify an empty bucket without accessing the off-chip memory. Clearing a bit in the bitmap is equivalent to deleting the element in the corresponding bucket.

For a static set of elements, the first hash function may be used until all of the buckets on the first hash function are filled. The remaining elements are then used on the second hash function and so forth, until all the elements are inserted.

In conventional Peacock hashing, a main hash table does not have an on-chip Bloom filter. The off-chip memory is partitioned into multiple tables so that the main table only uses a portion of the memory. As a result, a much smaller set of elements can be handled by the main table in order to avoid being programmed in the Bloom filters. Thus, while Peacock hashing partitions the memory, coded hashing according to example embodiments considers the entire memory space as a whole and encodes the hash functions that can address every location of the memory.

For dynamic elements sets, the elements are incrementally inserted into the hash-table. For example, when an n′ element of n elements is to be inserted, n′−1 elements have been successfully inserted using multiple hash functions. A probability that the n′ element can be handled by the default hash function is (m−(n′−1))/m, where m is the number of buckets of the off-chip hash-table.

A probability that the n′ element is handled by the k-th hash function is:

$${p}_{{n}^{′} , k} = {( \frac{{n}^{′} - 1}{m} )}^{k - 1} \cdot \frac{m - ( {n}^{′} - 1 )}{m} \qquad ( 3 )$$

Therefore, an expected number of elements that are handled by the default hash function is:

$${E}_{default} = {\sum }_{i = 1}^{n} \frac{m - ( i - 1 )}{m} = \frac{( 2 m + 1 ) n - {n}^{2}}{2 m} \qquad ( 4 )$$

The percentage of elements that can be handled by the default hash function is:

E_{default}/n=(2m+1)/m−α/2≈1−α/2 (5)

wherein α is the hash-table load factor (e.g., n/m).

From Equation (3), an expected number of elements that are handled by the k-th hash function is:

$${E}_{k} = {\sum }_{i = 1}^{n - 1} {( \frac{i}{m} )}^{k - 1} \cdot \frac{m - i}{m} \qquad ( 6 )$$

Equation (6) can be solved using Faulhaber's formula. The percentage of elements handled by the k-th hash function is:

$${E}_{k} / n \approx \frac{{α}^{k - 1}}{k} - \frac{{α}^{k}}{k + 1} \qquad ( 7 )$$

For the dynamic set, the default hash functions handle less elements than that for the static set. However, they converge as more hash functions are added.

At S320, the index of the selected hash value is encoded by the ECOMB 115 as a hash function ID. In at least one example embodiments, the ECOMB 115 does not store a hash function ID when all the elements are guaranteed to be in the hash-table.

The hash function ID may be stored by programming the element into different Bloom filters based on their set membership. A number of logical Bloom filters y is a factor that determines an achievable false positive rate when a size of the on-chip memory and a number of elements n are fixed.

The ECOMB 115 uses constant weight codes with a weight of w. The number of ‘1’ bits in a block code is defined as the weight (e.g., 10010 has a weight of 2). Therefore, each element, based on its set membership, is programmed into a set of w logical Bloom filters. Consequently, w is the same as y. For example, if 10 Bloom filters are available and each element is only programmed into two Bloom filters, the configuration may support

$$( \begin{matrix}10 \\ 2\end{matrix} )$$

which equals 45 sets.

In more detail, a 10-bit block can support 45 unique codes, given a weight of 2 (which is 10 choose 2). 10 Bloom filters may be allocated. In an example, an element belongs to set 2 (e.g., the element uses the hash function with the hash function ID 2) and set 2 is assigned a code 1010000000. Therefore, the element is programmed into first and third Bloom filters. When the Bloom filter is searched using the same element, assuming no false positive, the first and the third Bloom filter will return a match, thus confirming that the element belongs to set 2. Hence hash function with the hash function ID 2 is used to hash the element to generate the address to the hash table.

Using a code with larger weight can reduce the number of Bloom filters used. For example, to support 128 sets, when w is 2 or 3, 17 or 11 Bloom filters are used. However, because the Bloom filter load increases multiple times, the misclassification rate and classification failure rate is worse than for the case when w is 1. Thus, the number of Bloom filters may be traded off by using a constant weight error correction code.

FIG. 4 illustrates a method of retrieving an element according to an example embodiment.

At S400, an element is received by the hash generator 105 and the ECOMB 115. The hash generator 105 outputs a series of hash values and the ECOMB 115 outputs the hash function ID (index) to the selector at S410. The hash function ID indicates the hash function that was selected (e.g., S310) to initially store the element.

If the element is not stored, the ECOMB lookup may not return a valid ID, implying that the default hash function is used. In case a false positive leads to a false ID, the false ID is used to retrieve the value in the hash table. The element is typically stored along with its associated value in the hash table, so the false positive may be filtered out by comparing the retrieved element with the element used for the lookup.

In one example embodiment, when the ECOMB 115 returns no hash function ID, the coded hashing system 100 may infer that the default hash function is the one to be used.

At S415, the selector 110 selects the hash value generated by the hash function indicated by the hash function ID. The selected hash value is an address used to retrieve the element and the associated value from the off-chip hash-table.

If there is no false positive (or the false positive has been corrected by the ECOMB 115) in the ECOMB 115 retrieval, perfect hashing is realized.

As described above, coded hashing according to example embodiments maximizes bandwidth utilization of an interface between the on-chip data side and the off-chip hash-table by inspecting one single element bucket in the off-chip hash-table. In other words, example embodiments minimize bandwidth (by requiring just one off-chip memory access per element lookup) to maximize the lookup throughput.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A method of processing elements in a system, the method comprising:
receiving, by the system, a first element;
generating, by the system, a first plurality of hash values based on the first element and a first plurality of hash functions;
determining, by the system, a first plurality of buckets in a table based on the first plurality of hash values, each of the first plurality of buckets associated with a different one of the hash values;
selecting, by the system, one of the first plurality of buckets;
storing, by the system, a first associated value in the selected bucket, the first associated value being associated with the first element; and
encoding an identifier (ID) of the hash function generating the hash value associated with the selected bucket into a filter based on the hash value.

2. The method of claim 1, wherein the selecting selects an empty bucket of the first plurality of buckets.

3. The method of claim 1, further comprising:
retrieving a second element and a second associated value from the table based on a look-up request.

4. The method of claim 3, wherein the retrieving includes,
generating a second ID using the filter based on the second element,
determining a second hash value using a hash function indicated by the second ID, and
outputting the second associated value stored in the table in a bucket indexed by the second hash value.

5. The method of claim 4, wherein the retrieving includes,
generating a second plurality of hash values from a second plurality of hash functions based on the look-up request,
selecting one of the second plurality of hash values based on the second ID, and
outputting, by the table, the second associated value based on the selecting.

7. The method of claim 4, wherein the second ID is the first ID if the second element is the first element.

8. The method of claim 4, wherein the generating the second ID includes,
generating a plurality of filter hash values based on the second element and a plurality of filter hash functions, and
filtering the plurality of filter hash values, the second ID being based on the filtering.

9. The method of claim 8, wherein the filter is a Bloom filter.

10. The method of claim 9, wherein the retrieving includes,
generating a second plurality of hash values from a second plurality of hash functions based on the look-up request,
selecting one of the second plurality of hash values based on the second ID, and
outputting, by the table, the second associated value based on the selecting.

11. A method of retrieving elements from a table in a system, the method comprising:
receiving, by the system, a look-up request for a first element;
first determining, by the system, an identifier (ID) based on the look-up request, the ID identifying a hash function used to store the first element and a value associated with the first element;
second determining, by the system, whether the first element is stored in the table based on the ID; and
outputting the first element and the value associated with the first element based on the second determining.

12. The method of claim 11, wherein the first determining includes,
receiving, by the filter, the first element,
generating the ID based on the first element, and
outputting, by the filter, the ID.

13. The method of claim 12, wherein the generating the ID includes,
generating a plurality of filter hash values based on the first element and a plurality of filter hash functions, and
filtering the plurality of filter hash values, the ID being based on the filtering.

14. The method of claim 12, wherein the second determining includes,
generating, by the system, a plurality of hash values based on the first element and the plurality of hash functions, the plurality of hash values being index values for the table, and
selecting one of the plurality of hash values based on the ID.

15. The method of claim 14, wherein the selecting includes,
receiving, at a selector, the ID outputted from the filter.

16. The method of claim 14, wherein the outputting includes,
retrieving the first element and the associated value from the table, the selected hash value being an address of the table having the associated value.

17. The method of claim 16, wherein the retrieving includes,
inspecting only the address having the associated value.

18. A hashing system comprising:
a hash generator configured to receive an element and generate a plurality of hash values based on the element and a plurality of hash functions;
a selector configured to select one of a plurality of buckets in a hash table based on the plurality of hash values, each of the plurality of buckets associated with a different one of the hash values;
the hash table having the plurality of buckets, the hash table configured to store a value associated with the element in the selected bucket; and
a filter configured to encode an identifier (ID) of the hash function generating the hash value associated with the selected bucket.
